(19) United States
(12) Patent Application Publication
(10) Pub. No.: US 2015/0303436 A1
(43) Pub. Date: Oct. 22, 2015

(54) METHOD OF MANUFACTURING A LEAD-ACID BATTERY

(71) Applicant: Energy Power Systems LLC, Troy, MI (US)

(72) Inventors: William Koetting, Davisburg, MI (US); Kwak Tom, Madison Heights, MI (US); Art Holland, Commerce Twp, MI (US); James Carlson, Troy, MI (US); Michael Nielson, Royal Oak, MI (US); Fabio Albano, Royal Oak, MI (US); Subhash Dhar, Bloomfield Hills, MI (US); Will Koederitz, Davisburg, MI (US); Joshua Payne, Royal Oak, MI (US); Jorge Espinel, Troy, MI (US); Jean-Paul Ortiz, Rochester Hills, MI (US)

(21) Appl. No.: 14/753,478

(22) Filed: Jun. 29, 2015

Related U.S. Application Data
(63) Continuation-in-part of application No. 14/145,692, filed on Dec. 31, 2013.
Application No. 14/145,692 is a continuation-in-part of application No. 13/766,991, filed on Feb. 14, 2013, now Pat. No. 8,808,914.
Application No. 13/766,991 is a continuation of application No. PCT/US2013/021287, filed on Jan. 11, 2013.
Application No. PCT/US2013/021287 is a continuation of application No. 13/626,426, filed on Sep. 25, 2012.
Application No. 13/626,426 is a continuation-in-part of application No. 13/350,505, filed on Jan. 13, 2012.
Application No. 13/350,505 is a continuation-in-part of application No. 13/350,686, filed on Jan. 13, 2012.

(51) Int. Cl. H01M 2/26; H01M 2/30; H01M 10/12

(52) U.S. Cl. CPC H01M 2/266; H01M 10/12; H01M 2/30; H01M 2220/20

(57) ABSTRACT

The present disclosure relates to a method of manufacturing a lead-acid battery, the method including: (i) extending a current collector from an end of a cell pack; and (ii) laser-welding a bus bar to the current collector.

### RELATED APPLICATIONS

This application is a continuation-in-part of U.S. application Ser. No. 14/145,692, filed Dec. 31, 2013, entitled “Lead-Acid Battery Having Versatile Form Factor.” This application claims priority to PCT International Application No. PCT/US2013/021287, filed on Jan. 11, 2013, and is a continuation in part of application Ser. No. 13/626,426, filed on Sep. 25, 2012, entitled “Lead-acid battery design having versatile form factor,” which is a continuation in part of application Ser. No. 13/350,686, filed Jan. 13, 2012, also entitled “Lead-acid battery design having versatile form factor,” which incorporates the entire disclosure of the concurrently filed U.S. application Ser. No. 13/350,505, entitled, “Improved Substrate for Electrode of Electrochemical Cell.” This application hereby incorporates, by reference, the entire contents of all the above-listed applications.

### TECHNICAL FIELD

Embodiments of the present disclosure relate generally to electrochemical cells. More particularly, embodiments of the present disclosure relate to the manufacture of lead-acid batteries by laser welding technologies.

### BACKGROUND

Lead-acid batteries are commonly used in vehicles for starting, lighting, and ignition (or SLI). Lead-acid batteries are a familiar electrochemistry for most vehicle manufactures. Lead-acid batteries may also provide motive power and are less expensive relative to Li-ion batteries, Ni-MH batteries, and fuel cells. It is desirable to develop more readily manufacturable and cost-effective lead-acid battery designs.

Current techniques for fastening the cells to the bus bar of lead-acid batteries include various mechanical fasteners and advanced joining techniques, including ultrasonic welding. A bus bar may be connected to the cell tab in a variety of ways. These connection methods may result in higher or lower internal resistance in the battery. One method employed by some of the present inventors is to ultrasonically weld the cell tabs to the bus bar. See e.g., Dhar, et al., U.S. Pat. No. 8,808,914, for “Lead-Acid Battery Design Having Versatile Form Factor,” which is incorporated herein by reference in its entirety as if fully set forth herein. Several different techniques for connecting the current collector to the bus bar are disclosed in the '914 patent. FIGS. 15A-D of the '914 disclosure depict ultrasonically welding the current collector to the bus bar. Ultrasonic welding, however, can require the use of additional material to connect the current collector and bus bar. The use of additional material to support ultrasonic welding increases material costs.

Laser welding is a known-technique for attaching metallic materials to one another. Laser welding offers greater precision, greater efficiency, a smaller weld-zone, and greater structural flexibility than alternative attachment techniques. Typically, laser welding generates temperatures in excess of 1,000° F. at the weld zone. The lower melting point of lead and of most lead-alloys is approximately 621.5° F., which discourages the use of laser welding in lead-acid batteries. Laser welding also costs more to implement than ultrasonic welding. For these reasons many manufacturers are deterred from laser welding lead-acid batteries.

### SUMMARY

In various embodiments, a lead-acid battery includes: a cell pack; a current collector extending from an end of the cell pack; and a bus bar attached to the current collector. In a preferred embodiment, the current collector includes a first portion and a second portion, the second portion being folded with respect to the first portion to extend substantially parallel to a longitudinal axis of the bus bar to provide increased contact area for laser welding.

In alternative embodiments, an electric vehicle powertrain assembly includes: an alternate power source; and a lead-acid battery for motive power. Embodiments of the present disclosure may be used for a variety of applications, including stop-start, mild hybrid, full hybrid, electric vehicle, and other vehicle and stationary power applications. The battery may include: one or more electrochemical cells; a current collector extending from an end of a cell pack; and a bus bar attached to the current collector. The current collector preferably includes a first portion and a second portion, the second portion folded with respect to the first portion so as to extend substantially parallel to a longitudinal axis of the bus bar.

In other embodiments, a method of manufacturing a lead-acid battery includes: (i) extending a current collector from an end of a cell pack; and (ii) laser-welding a bus bar to the current collector.

One advantage of certain embodiments of the present disclosure is improved connectivity between the current collector and the bus bar. This in turn may result in lower internal resistance of the battery relative to other batteries in which the current collector is connected to the bus bar by alternative means.

Advantages of certain embodiments in which the current collector is laser-welded to the bus bar may include ease of manufacture, reduced material requirements to make an effective connection, reduced battery weight, and potentially, improved fuel efficiency. This in turn may help reduce weight of the battery and vehicle powertrain assemblies, and, potentially, improve fuel efficiency.

Additional advantages of the disclosure will be set forth in part in the description which follows, and in part will be apparent from the description, or may be learned by practice of the disclosure. The advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one or more exemplary embodiments of the disclosure and together with the description, serve to exemplify the principles of the disclosure.

The following detailed description refers to the accompanying drawings. Wherever possible, the same reference numbers may be used in the drawings and the following description to refer to the same or similar parts. Details are set forth to aid in understanding the embodiments described herein. In some cases, embodiments may be practiced without these details. In others, well-known techniques and/or components may not be described in detail to avoid complicating the description. While several exemplary embodiments and features are described herein, modifications, adaptations and other implementations are possible without departing from the spirit and scope of the invention as claimed. The following detailed description does not limit the invention. Instead, the proper scope of the invention is defined by the appended claims.

### BRIEF DESCRIPTION OF THE DRAWINGS

FIG. 1 is a schematic diagram of a preferred embodiment of a battery of the present disclosure, shown in partial cut-away.

FIG. 2 is a schematic diagram of an exploded view of the battery of FIG. 1.

FIG. 3 is a schematic diagram of the battery of FIG. 1, at a first stage in a manufacturing process.

FIG. 4 is a schematic diagram of the battery of FIG. 1, at a second stage in the manufacturing process.

FIG. 5 is a schematic diagram of the battery of FIG. 1, at a third stage in the manufacturing process.

FIG. 6 is a schematic diagram of another battery according to an exemplary embodiment at a later stage in the manufacturing process.

FIG. 7 is a schematic diagram depicting a micro-hybrid-electric vehicle powertrain.

FIG. 8 is a schematic diagram of an electric vehicle powertrain.

### DETAILED DESCRIPTION

Embodiments of the present disclosure may improve connectivity between the current collector and bus bar, lower resistance, improve manufacturability, reduce material cost, and reduce weight. In a vehicle application these embodiments may offer improved fuel efficiency. Exemplary methods can be implemented singularly or applied in mass-producing batteries.

Voltage or other performance characteristics can be modified by changing the number of cells within a battery and modifying the manner of connecting cells, cell size, the number of cells per module, or the configuration of the cells. The present disclosure applies to batteries within any range of voltages, power requirements, or energy demands.

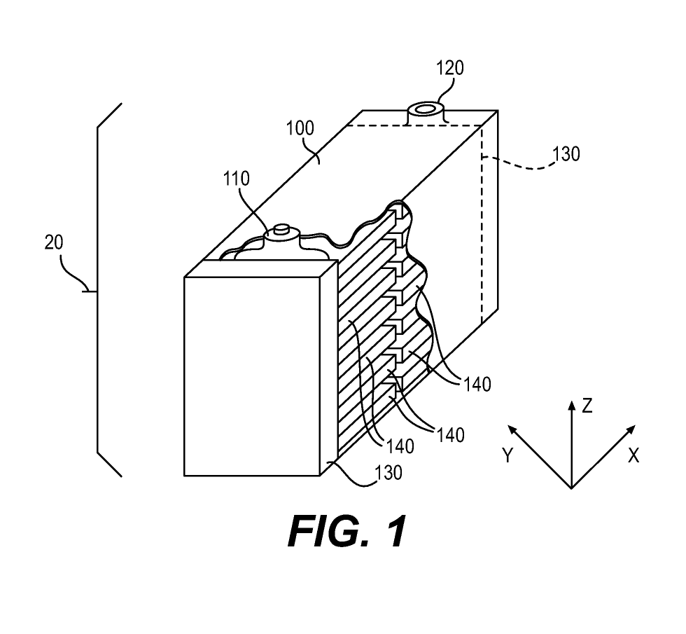

Preferred embodiments relate to an improved electrochemical energy storage device FIG. 1 depicts an electrochemical energy storage device including a plurality of electrochemical cells, each having one or more pairs of electrodes and current collectors. The electrode plates and current collectors may be arranged in a stacked or multi-layered structure. The stacked structure may include electrochemical cells oriented vertically or horizontally. A tab or current collector may extend from an end of each cell. Current collectors are attached, preferably by laser welding, to a bus bar connecting the current collector(s) to a battery terminal. Embodiments of the present disclosure relate to a battery having an improved bus bar connection and an improved manufacturing technique for attaching the bus bar to the current collector(s).

FIG. 1 is a partial cut-away, orthogonal view of battery pack 20. Battery 20 includes outer casing 100. FIG. 1 depicts casing 100 partially cut away to expose a portion of the cells of battery 20. Battery 20 comprises terminals 110, 120 of opposite polarity. FIG. 1 depicts positive terminal 110 and negative terminal 120. A bus bar 130 is connected to each terminal 110 and 120.

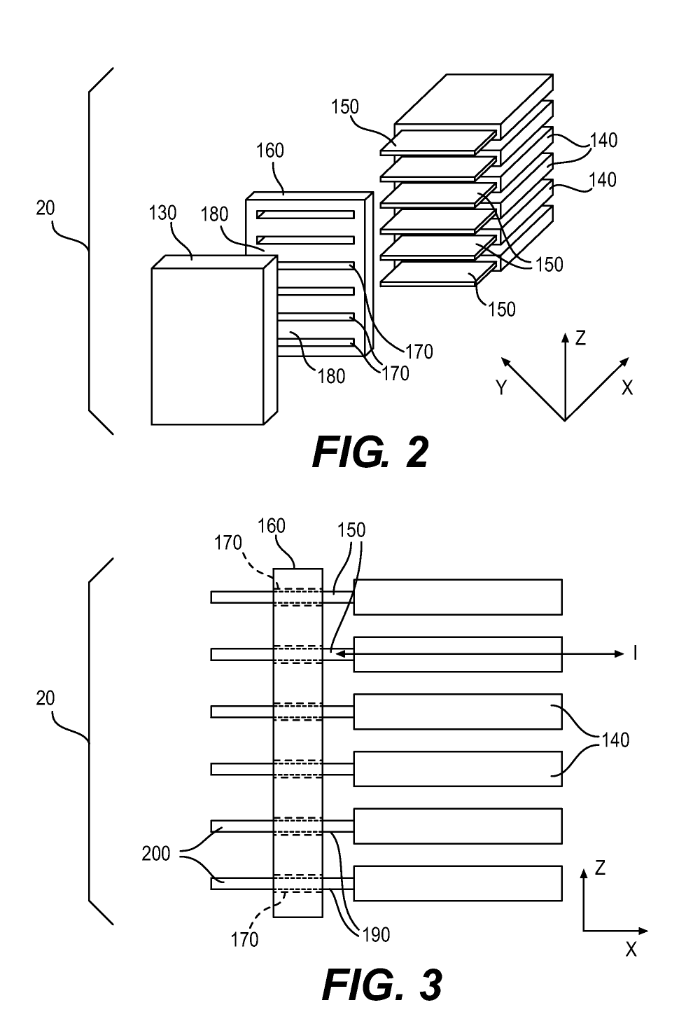

FIG. 2 is an exploded view of a portion of battery 20 of FIG. 1. FIG. 2 depicts current collectors or tabs 150 extending from each cell 140. Current collectors 150 are connected to bus bar 130, preferably by laser welding.

As depicted in FIG. 2, bus bar 130 is preferably a solid structure comprising a sheet of metal. Bus bar 130, as depicted in FIGS. 2 and 3, is commonly referred to as a “ribbon style power bus.” Bus bar 130 comprises conductive material, preferably, lead. Bus bar 130 preferably has low mass, low electrical resistance, and high environmental and corrosion resistance. In other embodiments, bus bar 130 may comprise copper or other conductive materials. In the embodiment depicted in FIGS. 2 and 3, bus bar 130 conducts current from current collectors 150 to terminal 110, as shown in FIG. 1.

In this embodiment, battery 20 may include alignment member 160 positioned between cell packs 140 and bus bar 130. Alignment member 160 assists in positioning current collectors 150 relative to bus bar 130. Alignment member 160 preferably includes slots 170 corresponding to the number of current collectors 150, being connected to bus bar 130. As depicted in FIG. 3, slots 170 are defined in part by alignment member 160 and rails 180 extending across a width of alignment member 160. Slots 170 are configured to accept current collectors 150.

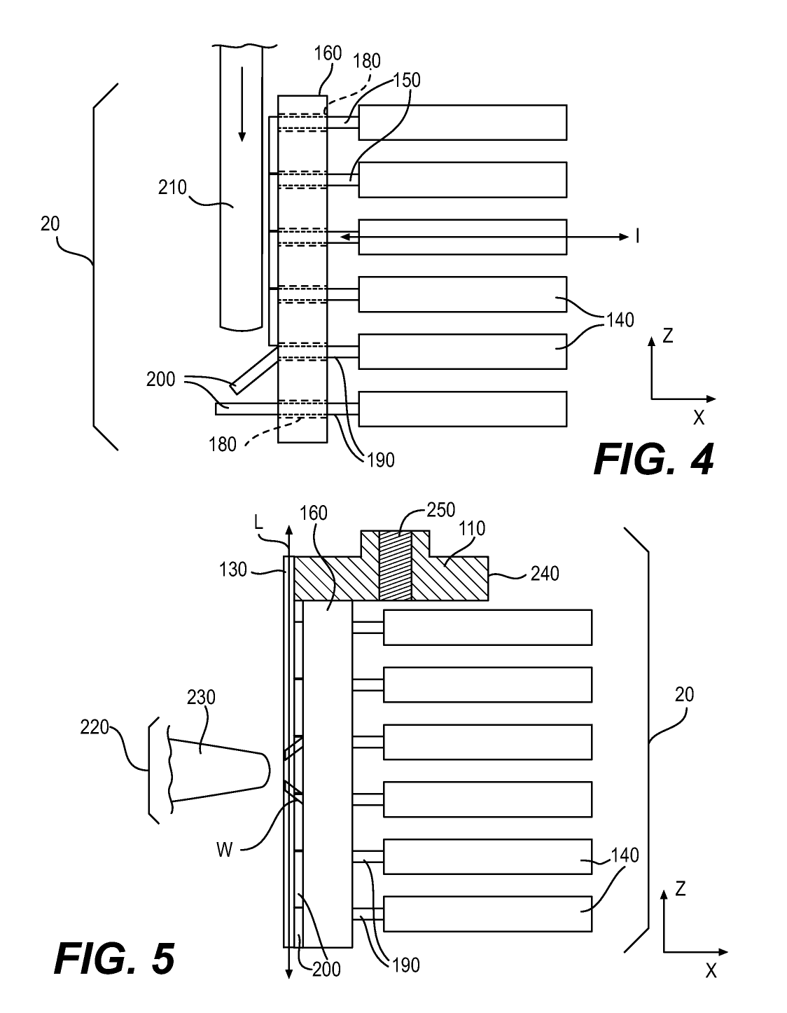

FIGS. 3 and 4 depict alignment member 160 comprising a non-conductive material, e.g., a polymer. Alignment member 160 may be formed by injection molding. In other embodiments, alignment member 160 may comprise other conductive or non-conductive materials and may be formed by any suitable method, e.g., stamping or cutting. Alignment member 160 may comprise silicon or any of various polymers or metals suitable for use in a battery.

In various embodiments, power bus 130 provides a balanced path for conducting electrons from cells 140 to terminals 110, 120. In certain embodiments, bus bar 130 may be provided with non-uniform resistivity along its extent to provide a balanced, or approximately balances, resistance between each current collector 150 and corresponding terminal 110 or 120. In various embodiments, resistivity of bus bar 130 may be increased by removing portions of a surface of bus bar 130 to create orifices or by altering bus bar 130 thickness during or after forming. In various embodiments, a desired resistivity value is a function of the location on the bus bar and may preferably be determined by modeling various paths for electrons between current collectors 150 and terminals 110, 120.

FIG. 4 depicts current collectors 150 laced or threaded through slots 170 of alignment member 160. FIG. 4 is a schematic, side view of battery pack 20 at a first stage of a manufacturing process. “First” depicts the stage relative to other pertinent processing steps and is not intended to convey that this stage precedes all others stages in the manufacture of a battery. Current collectors 150 include a portion 190 proximate to cell 140 and a portion 200 distal from cell 140. Portion 200 is disposed through slots 170 in alignment member 160. As depicted in FIG. 4, portions 190 and 200 extend substantially parallel to a longitudinal axis of cell pack, l.

FIG. 5 depicts a subsequent stage in the manufacture of battery 20. As depicted in FIG. 5, portion 200 of current collector 150 may be folded over rail 180 of alignment member 160 so that it is disposed in a direction at a right angle to proximate portion 190 and substantially perpendicular to the longitudinal axis of cell pack, l. In this embodiment, a mandrel 210 may be applied to portion 200 of current collectors 150 to fold portion(s) 200 against alignment member 160, portion(s) 190 remaining substantially parallel to longitudinal axis of cell pack, l.

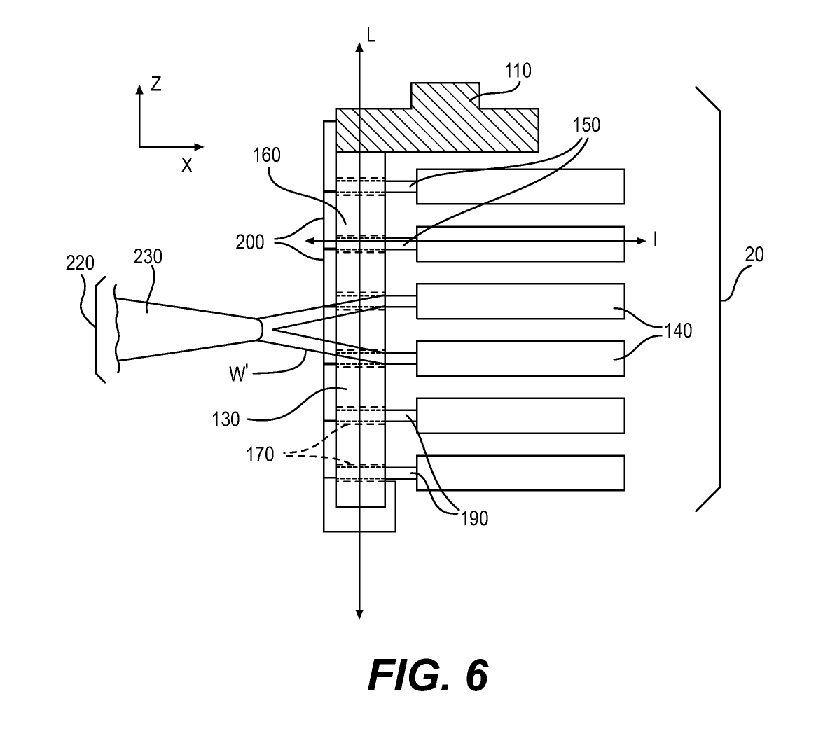

FIGS. 5 and 6 depict embodiments of the present disclosure in which longitudinal axis of cell pack, l, is oriented substantially perpendicular to longitudinal axis of bus bar, L. Portion 200 of current collector 150 may be configured to rest flush against bus bar 130. The area of contact between portion 200 and bus bar 130 is increased by the folded disposition of portion 200.

In other embodiments, portion 200 of current collectors 150 may be folded upwards relative to bus bar 130 (e.g., as shown in FIG. 6). This alternative configuration may reduce resistance when battery terminals 110, 120 are positioned in the same direction in which portion(s) 200 are folded.

FIG. 5 depicts bus bar 130 being laser welded to current collector portion 200 using laser weld apparatus 220. Apparatus nozzle 230 generates a weld zone, W, affecting a targeted current collector portion 200. In various embodiments, the thickness of bus bar 130 is in a range of 0.02-0.04 inches. In a preferred embodiment, with the surfaces of bus bar 130 and current collector 200 being 0.032 inches and 0.016 inches thick respectively, a power setting for laser-weld apparatus 220 may be between 500 and 1,000 watts. In other embodiments, power setting can be greater or lower. For each current collector portion 200, of approximately 4 inches in length, apparatus 220 exposes bus bar 130 and collector portion 200 to 0.25 to 1 seconds of curing in this embodiment. Exposure time may vary in different embodiments. In one embodiment, bus bar 130 is formed before laser welding current collectors 150 thereto and in alternative embodiments bus bar 130 may be formed after laser welding current collectors thereto.

FIGS. 5 and 6 depict bus bar 130 affixed to terminal 110 by laser welding. Terminal 110 comprises an outer shell 240 comprising lead and is weld-compatible with bus bar 130. In preferred embodiments, terminal 110 further comprises a copper core 250 to increase connectivity and conductivity. In other embodiments, terminal 110 may comprise other suitable materials, well-known in the art (e.g., terminal 110 is composed of lead in the embodiment of FIG. 6).

FIG. 6 depicts an alternative embodiment in which battery 20 includes current collector 150 distal portion 200 folded upwards with respect to bus bar 130. FIG. 6 illustrates a section of battery pack 20 at a later stage in a manufacturing process. Battery 20 includes cell 140 having current collectors 150 extending from the cell packs. A longitudinal axis of cell pack, l, runs substantially perpendicular to a longitudinal axis of bus bar, L.

As depicted in FIG. 6, bus bar 130 abuts distal end 200 of current collector 150 extending upwards to facilitate welding of bus bar 130 to terminal 110.

In a preferred embodiment of the present disclosure, portions 200 of current collector 150 are disposed to rest flush against bus bar 130. Contact between current collector 150 and bus bar 130 is increased by disposing the folded portion 200 against bus bar 130.

Bus bar 130 is laser welded to each current collector portion 200 and terminal 110 using laser weld apparatus 220. Apparatus nozzle 230 generates a weld zone, W, affecting a targeted current collector portion 200. In this embodiment, a power setting for laser-weld apparatus 220 is between 200 W and 500 W. In other embodiments, the power setting can be greater or lower.

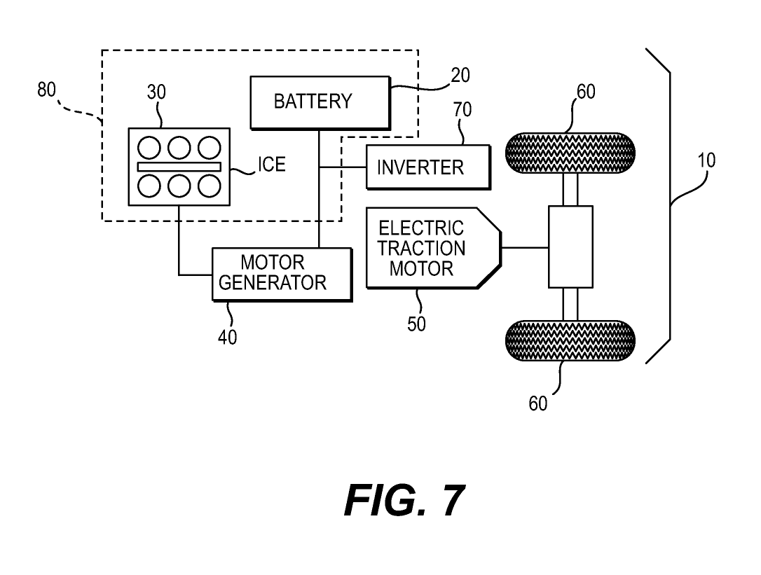

FIG. 7 depicts an exemplary application of an embodiment of the present disclosure for use in a hybrid-electric vehicle propulsion system. As depicted in FIG. 7, hybrid-electric vehicle 10 comprises battery 20 according to an exemplary embodiment of the present disclosure. Vehicle 10 may be a micro- or mild-hybrid electric vehicle. An internal combustion engine (ICE) 30 is linked to motor generator 40. Electric traction motor 50 is configured to provide energy to vehicle wheels 60. Traction motor 50 can receive power from either battery 20 or motor generator 40 through power inverter 70. In certain embodiments, motor generator 40 may be located in a wheel hub and directly linked to traction motor 50. In other embodiments, motor generator 40 may be directly or indirectly linked to a transmission configured to provide power to wheels 60. In other embodiments, regenerative braking is incorporated in vehicle 10 so that motor generator 40 receives power from wheels 60 as well.

Vehicle 10 includes a vehicle powertrain assembly 80 configured to propel vehicle 10. Powertrain assembly 80 includes battery 20 and an alternate power source, which in this case is an internal combustion engine 30. Either battery 20 or internal combustion engine 30 may propel vehicle 10 or both may act simultaneously to provide vehicle propulsion demands.

Battery 20 may be a lead-acid battery pack. In other embodiments, vehicle 10 may be an all electric vehicle. Vehicle 10 may be a hybrid-electric vehicle, plug-in hybrid electric vehicle, extended range electric vehicle, or, as shown, a mild-/micro hybrid electric vehicle.

Exemplary batteries disclosed herein may provide a reliable replacement for a Li-ion battery, Ni-MH battery or fuel cells in a vehicle powertrain application. Disclosed lead-acid traction batteries may also compliment other electrochemistries. The disclosed batteries may be combined in electric vehicle systems with other types of electrochemical cells to provide electric power tailored to the unique automotive application. See Dhar, et al., U.S. Patent Publication No. 2013/0244063, for “Hybrid Battery System for Electric and Hybrid Electric Vehicles” and Dasgupta, et al., U.S. Patent Publication No. 2008/0111508, for “Energy Storage Device for Loads Having Variable Power Rates,” both of which are incorporated herein by reference in their entireties. For example, lead-acid batteries can be combined with other alternate power sources other than an internal combustion engine, including Li-ion cells, Ni-MH cells or fuel cells to provide a composite battery system tailored to the needs of the particular automotive power application, while reducing the relative sizes of each component.

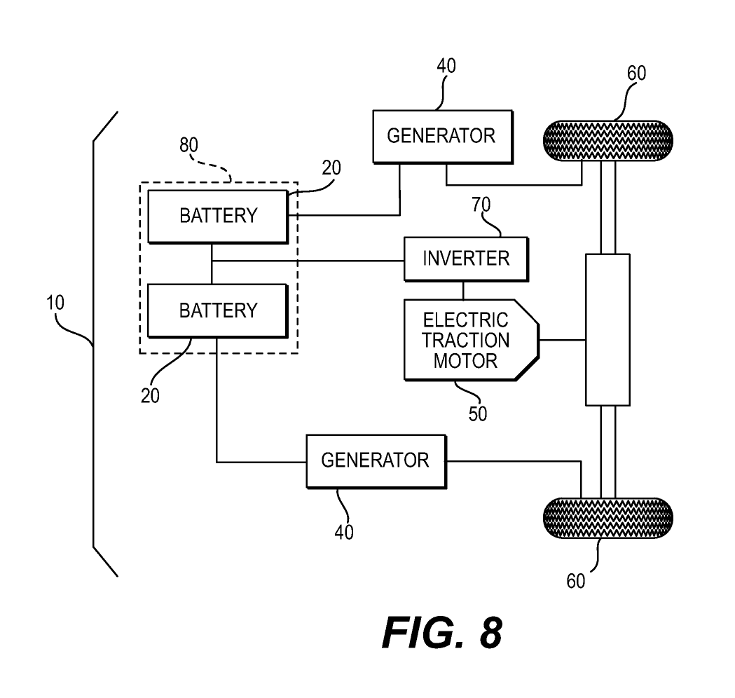

FIG. 8 depicts another exemplary application of an embodiment of the present disclosure for use in an electric vehicle propulsion system. As depicted in FIG. 8, electric vehicle 10 has a battery 20 according to an exemplary embodiment of the present disclosure. Vehicle 10 is an all electric vehicle. Electric traction motor 50 is configured to provide energy to vehicle wheels 60. Traction motor 50 can receive power from either battery 20 through power inverter 70. Generators 40 receive power from wheels 60 during braking and regenerate batteries 20.

Vehicle 10 of FIG. 8 includes a vehicle powertrain assembly 80 configured to propel vehicle 10. Powertrain assembly 10 includes battery 20 and an alternate power source, another battery 20, which in this case is a Li-ion battery pack. Either battery 20 may be used to propel vehicle 10 or both may act simultaneously to provide vehicle propulsion demands. One of batteries 20 may be a lead-acid battery.

Though the illustrated embodiments of the present disclosure relate to laser welding other laser techniques can be used to accomplish attachment of the bus bar, current collectors and/or terminals. For example, in one embodiment, current collectors are laser soldered to a bus bar terminal.

Embodiments of the present disclosure may be implemented in different types of batteries including, for example, solid-state batteries. The embodiments of the present disclosure are not limited to transportation and automotive applications. The disclosed embodiments may be of use in any area know to those skilled in the art where use of a lead-acid battery is desired, such as stationary power uses and energy storage systems for back-up (or emergency) power situations. Further, the elements or components of the various embodiments disclosed herein may be used together with other elements or components of other embodiments.

Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

We claim:

1. A lead-acid battery, comprising:
a cell pack;
a current collector extending from an end of the cell pack; and
a bus bar attached to the current collector;
wherein the current collector includes a first portion and a second portion, the second portion folded with respect to the first portion so as to extend substantially parallel to a longitudinal axis of the bus bar.

2. The lead-acid battery of claim 1, wherein the battery further comprises:
an alignment member through which the current collector is laced.

3. The lead-acid battery of claim 2, wherein the alignment member is composed of a non-conductive material.

4. An electric vehicle powertrain assembly, comprising:
an alternate power source; and
a lead-acid battery, the battery including:
a cell pack;
a current collector extending from an end of the cell pack; and
a bus bar attached to the current collector;
wherein the current collector includes a first portion and a second portion, the second portion folded with respect to the first portion so as to extend substantially parallel to a longitudinal axis of the bus bar.

5. The EV powertrain assembly of claim 4, wherein the battery further comprises:
an alignment member through which the current collector is laced.

6. The EV powertrain assembly of claim 5, wherein the alignment member is composed of a non-conductive material.

7. The EV powertrain assembly of claim 6, wherein the battery further comprises:
a terminal;
wherein the terminal is laser welded to the bus bar;
wherein the terminal is at least partially composed of lead.

8. The EV powertrain assembly of claim 7, wherein the terminal is at least partially composed of copper; and
wherein the copper is at least partially coated in lead.

9. A method of manufacturing a lead-acid battery, comprising:
extending a current collector from an end of a cell pack; and
laser-welding a bus bar to the current collector.

10. The method of claim 9, further comprising:
forming an alignment member.

11. The method of claim 10, further comprising:
lacing the current collector through the alignment member.

12. The method of claim 11, further comprising:
wherein the current collector includes a first portion and a second portion;
folding the second portion of the current collector with respect to the first portion.

13. The method of claim 12, wherein the folding the second portion includes folding the second portion so as to extend substantially parallel to a longitudinal axis of the bus bar.

14. The method of claim 13, further comprising:
folding the second portion of the current collector over a rail of the alignment member.

15. The method of claim 9, further comprising:
laser welding the bus bar to a terminal.

16. The method of claim 9, further comprising:
setting a laser-weld apparatus power setting to between 200 and 1,000 watts.

17. The method of claim 9, further comprising:
lacing the current collector through an alignment member.

18. The method of claim 17, further comprising:
wherein the current collector includes a first portion and a second portion;
folding the second portion of the current collector with respect to the first portion.

19. The method of claim 18, wherein the folding the second portion includes folding the second portion so as to extend substantially parallel to a longitudinal axis of the bus bar.

20. The method of claim 19, further comprising:
folding the second portion of the current collector over a rail of the alignment member.
